(19) United States
(12) Patent Application Publication
(10) Pub. No.: US 2025/0029024 A1
(43) Pub. Date: Jan. 23, 2025

(54) SYSTEMS AND METHODS FOR SMALL BUSINESS IDENTIFICATION THROUGH COMMUNITY CURATION

(71) Applicant: Wells Fargo Bank, N.A., San Francisco, CA (US)

(72) Inventors: Anita Sukur, Minneapolis, MN (US); Drew Jahn, Charlotte, NC (US); Huanchee Aaron Chan, Fort Mill, SC (US); Brent Teitel, New York, NY (US); Sean Pifferi, Saint George, UT (US); Jeffrey Dean, Bend, OR (US)

(21) Appl. No.: 18/047,050

(22) Filed: Oct. 17, 2022

(51) Int. Cl. G06Q 10/06; G06Q 30/02

(52) U.S. Cl. CPC G06Q 10/0631; G06Q 30/0203

(57) ABSTRACT

Systems, apparatuses, methods, and computer program products are disclosed for curating a community between a plurality of clients. An example method for curating a community between a plurality of clients includes authenticating a first client of the plurality of clients; obtaining first operation data of the first client; generating a first client profile for the first client; matching the first client to other ones of the plurality of clients using the first client classification; generating a community interaction portal that facilitates interaction between the first client and the other ones of the plurality of clients matched to the first client; and displaying the community interaction portal on a display.

### BACKGROUND

Entities and/or individuals may desire to obtain products and/or services from small businesses. Prior to obtaining products and/or services, entities and/or individuals may wish to identify small businesses that meet certain criteria. Computing devices may provide functionality for identifying criteria related to small businesses.

### BRIEF SUMMARY

Entities (e.g., businesses, individuals, or the like) may benefit from establishing relationships with small businesses and/or from obtaining products or services from small businesses. To choose which small businesses to establish relationships with and/or obtain products or services from, entities may wish to have information about these small businesses. However, it may prove difficult for entities to find accessible and reliable information about small businesses. For example, to obtain this information, entities are required to consult external sources (e.g., consultants, the Internet, etc.). However, these options may be cost prohibitive, may not be tailored to the needs of the entity, and/or may include fraudulent or misleading content. For example, information stored in publicly accessible locations (e.g., on a publicly accessible website, etc.) may be at risk of being manipulated (e.g., edited via manipulation of the website's source code, removed, etc.) by a third party (e.g., admin of the publicly accessible website, bad actors, etc.). In addition, publicly available information about small businesses on the Internet may be out-of-date. Certain information (e.g., revenue, number of employees, customer retention, or the like) may also be unavailable via publicly accessible sources. For these reasons, it is difficult for entities to make accurate informed decisions about small businesses.

Systems, apparatuses, methods, and computer program products are disclosed herein for curating a community (via a platform accessible through a communications network) to facilitate trusted interactions between clients of the platform (e.g., small businesses, individuals, etc.). As an example, assuming the clients are small businesses, small businesses participating in this curated community may be authenticated (e.g., using banking information) by the platform to ensure legitimacy of any search results provided to clients by the platform (e.g., to ensure the clients are legitimate small businesses). The platform may also: (i) classify clients into categories using a first inference model, (ii) generate client profiles, (iii) match clients with other clients that meet their needs using a second inference model, (iv) facilitate communication between clients (e.g., facilitate communication between a small business and other complementary small businesses).

For example, as a practical application of embodiments herein, an entity may be a small business interested in expanding operations by forming partnerships with other complementary small businesses. The first inference model may assign classifications to the small business and the second inference model may match the small business with existing clients of the platform. The platform hosting the operating the first and second inference models may continuously acquire data (e.g., via client surveys) regarding the accuracy of the classifications and the level of client satisfaction with the provided matches. This data may be used to continuously update training data sets for both the first and second inference model. By periodically re-training the first and second inference model using data obtained from clients, the platform may provide progressively more accurate and relevant results.

Furthermore, the platform may be hosted by a financial institution (e.g., a bank) and the entity may be an existing client of the financial institution. Therefore, the financial institution may already be storing data usable to authenticate the entity and train the inference models (e.g., existing records of the client and other clients of the financial institution). As a result, said financial institution would advantageously be able to provide the client with the ability to contact matching clients at significantly less cost and time than other third-party entities (e.g., third-party consulting).

Therefore, by participating in the community, clients may be advantageously provided with significantly more reliable and relevant information than may be obtained from, for example, an Internet search. While described above with reference to small businesses, the curated community may include other types of entities (e.g., individuals, charitable organizations, or the like) without departing from embodiments disclosed herein.

The first and second inference models may be cooperatively trained (e.g., the second inference model may be trained, at least in part, using output data from the first inference model, and vice versa). As a result, accuracy of the first and second inference models may increase over time. In addition, authenticating clients using banking information obtained through a secure communications network (e.g., the Internet via multi-factor authentication) provides increased data security for participants of the platform. Therefore, embodiments herein directly improve upon the field of utilizing inference models to authenticate, classify, and match clients.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a community curation manager that may perform various operations in accordance with some example embodiments described herein.

FIG. 3 illustrates an example flowchart for curating a community between a plurality of clients, in accordance with some example embodiments described herein.

FIG. 4 illustrates an example community interaction portal, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server. A server module (e.g., server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a computing device, such as a smart phone, thereby enabling it to function as an Internet server (e.g., an enterprise e-mail server) only to the extent necessary to provide the functionality described herein.

### Overview

As noted above, methods, apparatuses, systems, and computer program products are described herein that curate a community for entities to identify and interact with small businesses. Entities (e.g., businesses, individuals, or the like) may wish to obtain products and/or services from small businesses that meet certain criteria (e.g., a geographical location, a type of product or service offered, etc.). However, identifying and connecting with small businesses that meet those criteria may be challenging due to a lack of available and reliable information about small businesses from publicly accessible sources.

Example embodiments herein provide a platform for curating a trusted community of small businesses (and/or other entities). This platform may utilize a first inference model to classify entities by the above-mentioned criteria and a second inference model to match classified entities to other entities participating in the platform. Entities may be authenticated (e.g., using banking information) to ensure legitimacy of client information accessible through the platform. Therefore, this platform may allow clients (e.g., businesses, individuals, or the like enrolled in the platform) to search for and/or establish contact with small businesses that meet their needs.

In some embodiments, a client may choose to join the curated community. Assuming, for this example, that the client is a small business, the small business may submit client experience data, which may be any form of data that can be used to confirm and/or prove that the client is a legitimate small business such as an employer identification number (EIN) verifiable by the internal revenue service (IRS), a Better Business Bureau (BBB) rating, one or more documents proving ownership of an asset (e.g., a property), one or more documents including tax records of the small business, or the like. Using the client experience data, the entity managing/hosting the platform on a publicly accessible sever may verify the authenticity of the small business. The authenticity of the small business may be verified by, for example, confirming an EIN number with the IRS. Alternatively, small businesses may be verified by collecting BBB ratings for the small business, collecting documentation of the number of employees of the small business, collecting documentation of the revenue of the small business, etc. Other types of clients (e.g., individuals) may be authenticated using other types of client experience data (e.g., social security numbers, or the like) without departing from embodiments disclosed herein.

Following authentication of the client, the platform may collect information about the client to populate a client profile and generate client matches to existing clients. To do so, a questionnaire may be transmitted to the client to obtain operation data. Operation data may include features such as: a number of employees of the client, zip code where the client is located, products or services provided by the client, etc. Operation data may be used to assign one or more classifications to the client as described below.

Operation data obtained from the client questionnaire may be fed into a first inference model trained to assign one or more classifications to the client. Classifications may be categories such as geographical location, number of employees, type of product or service offered, etc. A profile may be created for the client including the classifications (and/or portions of the operation data).

The classifications may then be used to match the client (e.g., a small business) with other clients (e.g., other small businesses) with similar classifications. To do so, the classifications may be fed into a second inference model trained to match the client to existing clients in the platform. Matches may include other clients with similar classifications as the client (e.g., nearby locations, similar numbers of employees, similar products or services offered, etc.).

These matches may be made available to the client via a community interaction portal (a graphical user interface (GUI)). The GUI may include graphical representations of each classification and each graphical representation may include a listing of one or more clients associated with that classification. The community interaction portal may allow clients to view client profiles, view client matches, and communicate with (e.g., via a chat or message function) the matched clients.

Accordingly, the present disclosure sets forth systems, methods, and apparatuses that curate a trusted community for clients to identify other clients (e.g., small businesses) that meet their needs and to communicate with said clients if desired.

Although a high-level explanation of the operations of example embodiments has been provided above, specific details regarding the configuration of such example embodiments are provided below.

### System Architecture

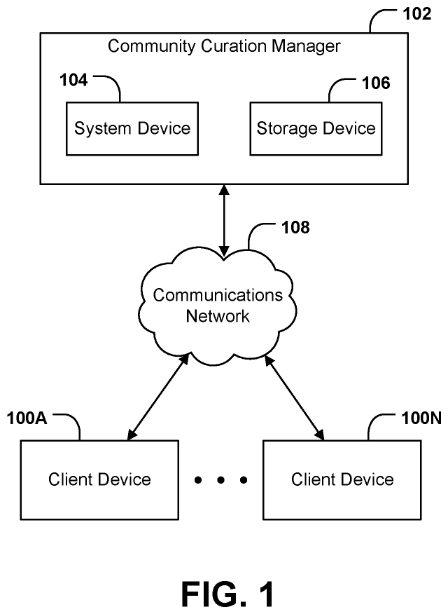

Example embodiments described herein may be implemented using any of a variety of computing devices or servers. To this end, FIG. 1 illustrates an example environment within which various embodiments may operate. As illustrated, a community curation manager 102 may include a system device 104 in communication with a storage device 106. Although system device 104 and storage device 106 are described in singular form, some embodiments may utilize more than one system device 104 and/or more than one storage device 106. Additionally, some embodiments of the community curation manager 102 may not require a storage device 106 at all. Whatever the implementation, the community curation manager 102, and its constituent system device(s) 104 and/or storage device(s) 106 may receive and/or transmit information via communications network 108 (e.g., the Internet) with any number of other devices, such as one or more of client devices 100A-100N.

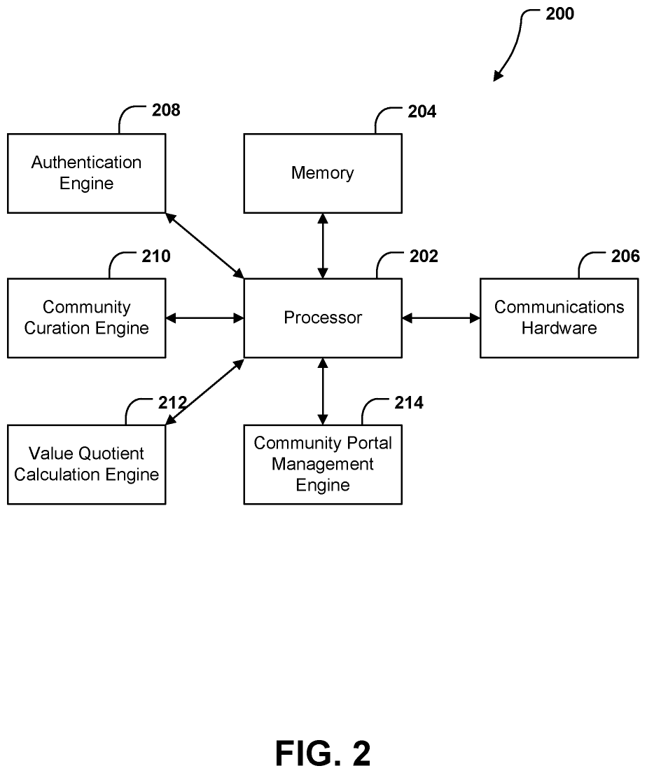

System device 104 may be implemented as one or more servers, which may or may not be physically proximate to other components of the community curation manager 102. Furthermore, some components of system device 104 may be physically proximate to the other components of the community curation manager 102 while other components are not. System device 104 may receive, process, generate, and transmit data, signals, and electronic information to facilitate the operations of the community curation manager 102. Particular components of system device 104 are described in greater detail below with reference to apparatus 200 in connection with FIG. 2.

Storage device 106 may comprise a distinct component from system device 104, or may comprise an element of system device 104 (e.g., memory 204, as described below in connection with FIG. 2). Storage device 106 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). Storage device 106 may host the software executed to operate the community curation manager 102. Storage device 106 may store information relied upon during operation of the community curation manager 102, such as various client experience data and operation data that may be used by the community curation manager 102, data and documents to be analyzed using the community curation manager 102, or the like. In addition, storage device 106 may store control signals, device characteristics, and access credentials enabling interaction between the community curation manager 102 and one or more of the client devices 100A-100N.

The one or more client devices 100A-100N may be embodied by any computing devices known in the art, such as desktop or laptop computers, tablet devices, smartphones, or the like. The one or more client devices 100A-100N need not themselves be independent devices, but may be peripheral devices communicatively coupled to other computing devices.

Although FIG. 1 illustrates an environment and implementation in which the community curation manager 102 interacts with one or more of client devices 100A-100N, in some embodiments users may directly interact with the community curation manager (e.g., via input/output circuitry of system device 104), in which case a separate client device (e.g., client device 100A) may not be utilized. Whether by way of direct interaction or via a separate client device 100A, a user may communicate with, operate, control, modify, or otherwise interact with the community curation manager 102 to perform the various functions and achieve the various benefits described herein.

### Example Implementing Apparatuses

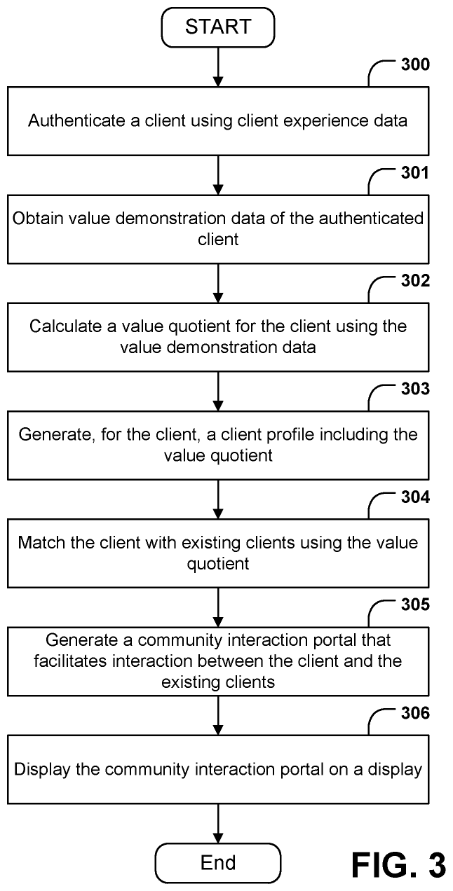

System device 104 of the community curation manager 102 (described previously with reference to FIG. 1) may be embodied by one or more computing devices or servers, shown as apparatus 200 in FIG. 2. As illustrated in FIG. 2, the apparatus 200 may include processor 202, memory 204, communications hardware 206 including input-output circuitry (not shown), authentication engine 208, community curation engine 210, and community portal management engine 212, each of which will be described in greater detail below. While the various components are only illustrated in FIG. 2 as being connected with processor 202, it will be understood that the apparatus 200 may further comprises a bus (not expressly shown in FIG. 2) for passing information amongst any combination of the various components of the apparatus 200. The apparatus 200 may be configured to execute various operations described above in connection with FIG. 1 and below in connection with FIG. 3.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor (e.g., software instructions stored on a separate storage device 106, as illustrated in FIG. 1). In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processor for causing transmission of such signals to a network or for handling receipt of signals received from a network.

The communications hardware 206 may include input-output circuitry (not shown) configured to provide output to a user and, in some embodiments, to receive an indication of user input. It will be noted that some embodiments will not include input-output circuitry, in which case user input may be received via a separate device such as a separate client device or the like. The input-output circuitry of the communications hardware 206 may comprise a user interface, such as a display, and may further comprise the components that govern use of the user interface, such as a web browser, mobile application, dedicated client device, or the like. In some embodiments, the input-output circuitry may include a keyboard, a mouse, a touch screen, touch areas, soft keys, a microphone, a speaker, and/or other input/output mechanisms. The input-output circuitry may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises an authentication engine 208 that authenticates clients (e.g., entities and/or individuals) as one or more predefined types of entities (e.g., a small business, an individual, or the like) using client experience data. The authentication engine 208 may utilize processor 202, memory 204, or any other hardware component included in the apparatus 200 to perform these operations, as described in connection with FIG. 3 below. The authentication engine 208 may further utilize communications hardware 206 to gather data from a variety of sources (e.g., client devices 100A-100N or storage device 106, as shown in FIG. 1), may utilize input-output circuitry of communications hardware 206 to receive data from a user, and in some embodiments may utilize processor 202 and/or memory 204 to authenticate clients using client experience data.

In addition, the apparatus 200 further comprises a community curation engine 210 that generates and populates client profiles. The community curation engine 210 may utilize processor 202, memory 204, or any other hardware component included in the apparatus 200 to perform these operations, as described in connection with FIG. 3 below. The community curation engine 210 may further utilize communications hardware 206 to gather data from a variety of sources (e.g., client devices 100A-100N or storage device 106, as shown in FIG. 1), may utilize input-output circuitry of communications hardware 206 to receive data from a user, and in some embodiments may utilize processor 202 and/or memory 204 to generate and populate client profiles.

Finally, the apparatus 200 also comprises a community portal management engine 212 that generates and manages a community interaction portal. The community portal management engine 212 may utilize processor 202, memory 204, or any other hardware component included in the apparatus 200 to perform these operations, as described in connection with FIG. 3 below. The community portal management engine 212 may further utilize communications hardware 206 to gather data from a variety of sources (e.g., client devices 100A-100N or storage device 106, as shown in FIG. 1), may utilize input-output circuitry of communications hardware 206 to receive data from a user, and in some embodiments may utilize processor 202 and/or memory 204 to generate and manage the community interaction portal.

Although components 202-212 are described in part using functional language, it will be understood that the particular implementations necessarily include the use of particular hardware. It should also be understood that certain of these components 202-212 may include similar or common hardware. For example, the authentication engine 208, community curation engine 210, and community portal management engine 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry,” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the authentication engine 208, community curation engine 210, and community portal management engine 212 may leverage processor 202, memory 204, or communications hardware 206 as described above, it will be understood that any of these elements of apparatus 200 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or memory 204, or communications hardware 206 for enabling any functions not performed by special-purpose hardware elements. In all embodiments, however, it will be understood that the authentication engine 208, community curation engine 210, and community portal management engine 212 are implemented via particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. Thus, some or all of the functionality described herein may be provided by third party circuitry. For example, a given apparatus 200 may access one or more third party circuitries via any sort of networked connection that facilitates transmission of data and electronic information between the apparatus 200 and the third-party circuitries. In turn, that apparatus 200 may be in remote communication with one or more of the other components describe above as comprising the apparatus 200.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a flowchart.

### Example Operations

Turning to FIG. 3, an example flowchart is illustrated that contains example operations implemented by example embodiments described herein. The operations illustrated in FIG. 3 may, for example, be performed by system device 104 of the community curation manager 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206 including input-output circuitry, authentication engine 208, community curation engine 210, community portal management engine 212, and/or any combination thereof. It will be understood that user interaction with the community curation manager 102 may occur directly via input-output circuitry of communications hardware 206, or may instead be facilitated by a separate client device 100A, as shown in FIG. 1, and which may have similar or equivalent physical componentry facilitating such user interaction.

Turning to FIG. 3, example operations are shown for curating a community between a plurality of clients.

As shown by operation 300, the apparatus 200 includes means, such as an authentication engine 208, or the like, for authenticating a client using client experience data. Client experience data may be any form of data that can be used to show and/or prove that the client is a predefined type of entity (e.g., a small businesses). The client experience data may include, for example, a tax identification number of the client (e.g., an employer identification number (EIN)), an amount of revenue generated by the client, a number of employees of a client, etc. The client experience data may be utilized (by the authentication engine 208) to verify that the client is a predefined entity (e.g., a small business).

For example, the community curation manager 102 may be hosted by a bank and the client may be a small business. If the small business is an existing client of the bank, the client may opt to participate in the curated community (e.g., via a mobile banking app). Existing banking data (e.g., including revenue, EIN, etc.) of the client may already be known to the bank and may be used as client experience data. If the small business is not an existing client of the bank, the small business may submit client experience data to the bank for verification via a communications network (e.g., communications network 108). For example, the client experience data may include an EIN and may be verified by the community curation manager 102 by verifying the EIN with the internal revenue service (IRS). Alternatively, small businesses may be verified by obtaining Better Business Bureau (BBB) ratings for the small business, obtaining documentation of the number of employees of the small business, obtaining documentation of the revenue of the small business, etc.

As shown by operation 301, the apparatus 200 includes means, such as communications hardware 206, or the like, for obtaining operation data of the authenticated client. To obtain operation data of the authenticated client, community curation manager 102 may generate a client questionnaire including questions related to the operations of the client (e.g., a name of the client, one or more zip codes associated with the client, a number of employees of the client, etc.) The client questionnaire may be transmitted to the client device 100A over a communications network (e.g., communications network 108) by communications hardware 206 of the apparatus 200. The client may input operation data into the client questionnaire. Operation data may include, for example, features such as a number of employees of the client, a location of the client, products or services provided by the client, etc. A completed one of the client questionnaire (also referred to herein as a “completed client questionnaire”) may be received by the community curation manager 102 (via communications hardware 206) from the client device 100A. The results obtained from the completed client questionnaire may be used to classify the client as described below.

As shown by operation 302, the apparatus 200 includes means, such as a community curation engine 210, or the like, for generating a client profile for the client. The client profile may include one or more classifications based on the operation data. To assign classifications, the community curation engine 210 may extract features from the operation data and match the features to features associated with a plurality of classifications known to the community curation engine 210. To do so, the community curation manager 102 may host and operate a first inference model as described below.

The first inference model may be a machine learning model (e.g., a neural network), an expert system, a regression model, and/or any other type of predictive engine trained to classify clients into client classifications (e.g., a city in which the client operates, a number of employees of the client, a type of product or service offered by the client, etc.). The first inference model may be a machine learning model trained using classification training data (data to be used for training the first inference model to assign classifications to clients). Classification training data may include a labeled data set of features and corresponding classifications.

For example, the community curation manager may be managed by and/or associated with a bank. In this example, the community curation manager may obtain classification training data from a sample of banking clients opting to participate in the platform. The bank may identify banking clients with certain classifications and subsequently utilize data of those clients to establish a training data set. The classification training data may be selected based on a wide range of features (e.g., a variety of geographical locations, a range of products/services offered, different numbers of employees, etc.). By doing so, the community curation manager 102 may better train the first inference model to avoid overfitting. The first inference model may take features from the completed client questionnaire as input data and generate classifications as output data. The classifications may be used to populate a client profile as described below.

The client profile may include the operation data associated with the client, as well as the classifications of the client. For example, to be classified within a particular geographical location, the small business must operate within a range of zip codes. The zip code within which the small business operates may be submitted as part of the client operation data and may be matched to a client classification (e.g., a geographical location) by the first inference model. The small business may then be classified as a small business operating within the specified geographical location.

For example, assume that the client is a small business bakery specializing in wedding cakes. The specialty of the small business may be a feature used by the first inference model to classify the small business as a wedding cake bakery. The client profile for this example small business may include: (i) the name of the business, and (ii) the classifications associated with the small business (e.g., locations serviced by the small business, types of products or services offered by the small business, etc.). The classifications may be used to match the client with other clients participating in the curated community as described below.

As shown by operation 303, the apparatus 200 includes means, such as a community curation engine 210, or the like, for matching the client with existing clients using the client classification. A plurality of existing clients may participate in the curated community. Some existing clients may have one or more identical classifications as the client. The community curation engine 210 may determine which existing clients have similar classifications to the client using a second inference model as described below.

The second inference model may also be hosted and operated by the community curation manager 102. The second inference model may be a machine learning model (e.g., a neural network), an expert system, a regression model, and/or any other type of predictive engine trained to match clients with existing clients based on the client classifications. The second inference model may be a machine learning model trained using matching training data. Matching training data may include a labeled data set of client matches considered useful by the clients. Matching training data may be obtained using ongoing client surveys to evaluate the client satisfaction with the matches provided by the platform. Therefore, the matching training data set may evolve over time and may progressively improve the accuracy of the second inference model. The second inference model may take combinations of classifications from the populated client profile as input data and generate matches to existing clients as output data.

As an example, the following classifications may be assigned to a small business based on a client questionnaire: (geographical location: Atlanta, Georgia, type of product or service offered: wedding cake bakery, number of employees: 15 or less). The community curation manager 102 may automatically match the small business with other small businesses participating in the platform with similar classifications. By doing so, the small business may easily be able to make trusted connections with other similar small businesses to improve and/or expand their operations.

The matches provided to the client by the community curation manager 102 may include a list of client profiles associated with existing clients of the platform. The client profiles may be displayed to the client in the form of true profiles or anonymous profiles. In some embodiments, a true profile may be a client profile where all sensitive information (e.g., name, telephone number, email, address, business logo, other business-related information including employee headcount or the like, etc.) associated with the client for which the profile is generated is shown (e.g., made public to others viewing the profile). In some embodiments, an anonymous profile may be a client profile in which one or more of the sensitive information associated with the client for which the profile is generated is censored, redacted, and/or hidden.

In some embodiments, the client may be able to choose whether to display a true profile or an anonymous profile to existing clients of the platform. If an anonymous profile is chosen, the community curation manager 102 may display the anonymous profile to existing clients upon generation of matches. The true profile associated with the client may be revealed to existing clients of the platform upon certain conditions being met. These conditions may include approval (by the owner of the anonymous profile) of a request and/or message from an existing client, approval of a collaboration between clients, etc.

A new client of the platform may initially choose whether to display a true profile or an anonymous profile upon submission of the client questionnaire. The client questionnaire may describe anonymous profiles and include a question prompting the client to choose whether to display an anonymous profile. The client may be able to change their preference later (e.g., by selecting a setting to display a true or anonymous profile using a graphical user interface, by contacting a customer service representative associated with the platform, etc.).

By allowing clients to display anonymous profiles, clients may decide whether to share sensitive information (e.g., name, telephone number, email, address, business logo, other business-related information including employee headcount or the like, etc.) with other clients of the platform when matches are generated by the community curation manager 102. These matches may be provided to clients via a community interaction portal as described below.

As shown by operation 304, the apparatus 200 includes means, such as a community portal management engine 212, or the like, for generating a community interaction portal that facilitates interaction between the client and the existing clients. The community interaction portal may be implemented with a graphical user interface (GUI). Generating the community interaction portal may include generating a graphical representation for each of the previously described plurality of classifications. The graphical representation of each of the plurality of classifications may include a listing of one or more of the plurality of clients. Therefore, the community interaction portal may include: (i) a client profile for each client of the plurality of clients and (ii) a communication portal for the client to contact the existing clients (e.g., via a chat or message function).

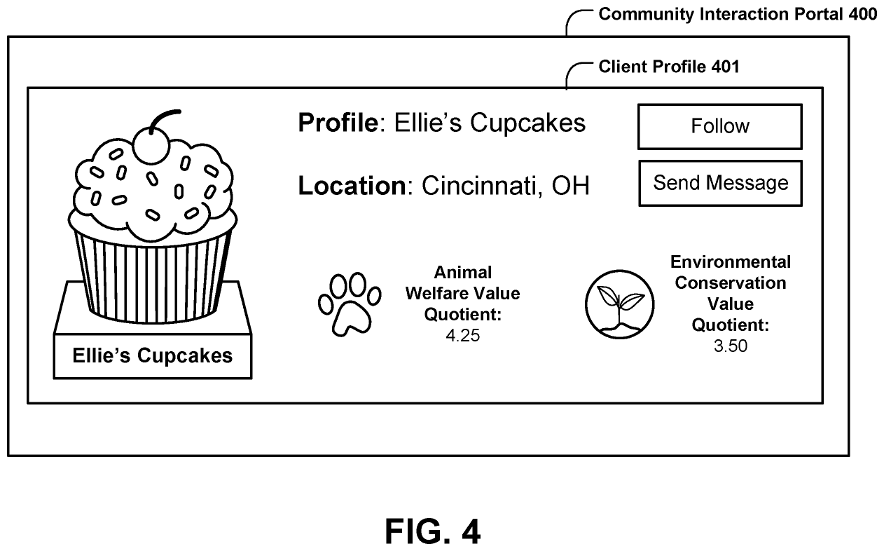

For example, the community interaction portal may display graphical representations (e.g., graphics) associated with the previously mentioned classifications. There may be a graphic labeled “wedding cake bakeries” and another graphic labeled with “Atlanta, GA.” The client may be able to select one or more of the classifications and view a listing of the clients associated with that classification. For example, the client may select “Atlanta, GA” and may see the clients operating within Atlanta, GA (e.g., in the form of true or anonymous profiles). Continuing with the above example where the client is a small business bakery specializing in wedding cakes, the client may be able to select “wedding cake bakeries” and further filter by geographical location. This may produce a list of wedding cake bakeries in the geographical location as the client. The client may then view the profiles of the other wedding cake bakeries operating in the same geographical location and may choose to contact the other wedding cake bakeries to ask for recommendations, advice, etc. An example communication interaction portal is shown below in more detail in reference to FIG. 4.

In a second example, a catering company may be looking to partner with a wedding cake bakery to streamline their wedding catering services. The catering company may search for “wedding cake bakeries” and filter by geographical location as previously described. The catering company may view the profiles of the wedding cake bakeries operating within the geographical location and may choose to contact certain wedding cake bakeries to establish a working relationship.

As shown by operation 305, the apparatus 200 includes means, such as communications hardware 206, or the like, for displaying the community interaction portal on a display. The community interaction portal may be made available to the client (e.g., via a link transmitted to the client through an email, text message, or the like) following authentication of the client. The community interaction portal may be accessible on a display via a client device (e.g., client device 100A) over a communications network (e.g., communications network 108).

The method may end following operation 305.

As described above, example embodiments provide methods and apparatuses that enable entities to access trusted information about small businesses. By curating a community of small businesses, clients (e.g., businesses and/or individuals participating in the community) may efficiently find information about small businesses, may be provided with a list of small businesses that match their needs, and/or may be able to easily communicate with small businesses via a community interaction portal.

Additionally, as these examples all illustrate, example embodiments contemplated herein provide technical solutions that solve real-world problems faced during the search for reliable information about small businesses. And while the reliability of publicly available information regarding small businesses has been an issue for decades, the recent advancements in manipulating publicly stored information has made this problem significantly more acute. At the same time, the recently rising ubiquity of the above-discussed problem has unlocked new avenues to solving this problem, and example embodiments described herein thus represent a technical solution to these real-world problems.

FIG. 3 illustrates operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### Example Community Interaction Portal

As described above, the community curation manager 102 may host a community interaction portal in the form of a graphical user interface (GUI) (e.g., a GUI displayed on a client device 100A) allowing clients to view and interact with client profiles. Turning to FIG. 4, the community interaction portal 400 is presented to a client (e.g., a first small business) via a GUI. By participating in the platform, the first small business has been provided with a list of matching small businesses. One of these matching small businesses is a second small business named Cakes by Alice.

In this example, the community interaction portal 400 shows a client profile 401 for the second small business named Cakes by Alice (as would be displayed to the first small business). The client profile 401 is a true profile of Cakes by Alice and includes all of the sensitive information associated with Cakes by Alice (at least all information provided directly by Cakes by Alice or retrieved from a public source) including Cakes by Alice's logo, Cakes by Alice's name, and the following classifications of Cakes by Alice: location, number of employees, and type of product/service offered. The client profile 401 also includes a functionality for the first small business to follow the client profile 401. Following the client profile 401 may provide the first small business with automatic updates regarding the activity of Cakes by Alice.

Alternatively, Cakes by Alice may choose to display an anonymous profile (not shown) to existing clients of the platform during searches and/or matches provided by the platform. For example, should Cakes by Alice wish to keep certain sensitive information anonymous until a later point in time, the selected sensitive information may be omitted, hidden, redacted, and/or censored from Cakes by Alice's anonymous profile. More specifically, Cakes by Alice's anonymous profile may show “Anonymous Client” instead of “Cakes by Alice” as the business name on the profile.

The community interaction portal 400 also includes matching information 402. As previously mentioned, Cakes by Alice is provided to the first small business as a match by the community curation manager 102. The matching information 402 includes a notification of a match, a description of the classifications the match was based on, and a functionality to contact Cakes by Alice (by sending a message). The functionality to contact Cakes by Alice may also include a chat box to open a chat with Cakes by Alice. In addition, the community interaction portal 400 may include a community chat function to facilitate chats among multiple clients of the platform at once.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for curating a community between a plurality of clients, the method comprising:
authenticating, by an authentication engine of a community curation manager, a first client of the plurality of clients;
obtaining, by communications hardware of the community curation manager, first operation data of the first client;
determining, by a community curation engine and using a first inference machine learning model, a first client classification;
generating, by the community curation engine of the community curation manager, a first client profile for the first client, wherein the first client profile comprises the first client classification;
matching, by the community curation engine and using a second inference machine learning model, the first client to other ones of the plurality of clients using the first client classification;
generating, by a community portal management engine of the community curation manager, a community interaction portal that facilitates interaction between the first client and the other ones of the plurality of clients matched to the first client; and
displaying, by the communications hardware, the community interaction portal on a display.

2. The method of claim 1, wherein authenticating the first client further comprises:
obtaining banking data of the first client; and
verifying that the first client is a small business entity using the banking data.

3. The method of claim 1, wherein obtaining the first operation data further comprises:
generating a client questionnaire;
transmitting the client questionnaire to the first client; and
receiving a completed one of the client questionnaire from the first client, wherein the completed one of the client questionnaire comprises the first operation data.

4. The method of claim 3, wherein the first operation data comprises:
a number of employees of the first client;
a location of the first client; and
products or services provided by the first client.

5. The method of claim 1, wherein generating the first client profile further comprises:
extracting, by the community curation engine, first features from the first operation data;
matching, by the community curation engine, the first features to features associated with a plurality of classifications; and
classifying, by the community curation engine, the first client into the first client classification using the first features, wherein the first client classification is one of the plurality of classifications.

6. The method of claim 5, wherein matching the first client to the other ones of the plurality of clients further comprises:
determining, by the community curation engine, that a second client comprises a second client classification identical to the first client classification, wherein the second client is one of the other ones of the plurality of clients.

7. The method of claim 6, wherein generating the community interaction portal further comprises:
generating, by the community portal management engine, a graphical representation for each of the plurality of classifications, wherein the graphical representation of each of the plurality of classifications comprises a listing of one or more of the plurality of clients.

8. The method of claim 6, wherein the community interaction portal comprises:
a second client profile of the second client; and
a communication portal for the first client to contact the second client.

9. A community curation manager for curating a community between a plurality of clients, comprising:
an authentication engine configured to authenticate a first client of the plurality of clients;
communications hardware configured to obtain first operation data of the first client;
a community curation engine configured to determine, using a first inference machine learning model, a first client classification;
the community curation engine further configured to generate a first client profile for the first client, wherein the first client profile comprises the first client classification;
the community curation engine further configured to match, using a second inference machine learning model, the first client to other ones of the plurality of clients using the first client classification;
a community portal management engine configured to generate a community interaction portal that facilitates interaction between the first client and the other ones of the plurality of clients matched to the first client; and
the communications hardware further configured to display the community interaction portal on a display.

10. The community curation manager of claim 9, wherein authenticating the first client further comprises:
obtaining banking data of the first client; and
verifying that the first client is a small business entity using the banking data.

11. The community curation manager of claim 9, wherein obtaining the first operation data further comprises:
generating a client questionnaire;
transmitting the client questionnaire to the first client; and
receiving a completed one of the client questionnaire from the first client, wherein the completed one of the client questionnaire comprises the first operation data.

12. The community curation manager of claim 11, wherein the first operation data comprises:
a number of employees of the first client;
a location of the first client; and
products or services provided by the first client.

13. The community curation manager of claim 9, wherein generating the first client profile further comprises:
extracting, by the community curation engine, first features from the first operation data;
matching, by the community curation engine, the first features to features associated with a plurality of classifications; and
classifying, by the community curation engine, the first client into the first client classification using the first features, wherein the first client classification is one of the plurality of classifications.

14. The community curation manager of claim 13, wherein matching the first client to the other ones of the plurality of clients further comprises:
determining, by the community curation engine, that a second client comprises a second client classification identical to the first client classification, wherein the second client is one of the other ones of the plurality of clients.

15. A non-transitory computer-readable storage medium for curating a community between a plurality of clients storing instructions that, when executed by a community curation manager, cause the community curation manager to:
authenticate a first client of the plurality of clients;
obtain first operation data of the first client;
determine, using a first inference machine learning model, a first client classification;
generate a first client profile for the first client, wherein the first client profile comprises the first client classification;
match, using a second inference machine learning model, the first client to other ones of the plurality of clients using the first client classification;
generate a community interaction portal that facilitates interaction between the first client and the other ones of the plurality of clients matched to the first client; and
display the community interaction portal on a display.

16. The non-transitory computer-readable storage medium of claim 15, wherein authenticating the first client further comprises:
obtaining banking data of the first client; and
verifying that the first client is a small business entity using the banking data.

17. The non-transitory computer-readable storage medium of claim 15, wherein obtaining the first operation data further comprises:
generating a client questionnaire;
transmitting the client questionnaire to the first client; and
receiving a completed one of the client questionnaire from the first client, wherein the completed one of the client questionnaire comprises the first operation data.

18. The non-transitory computer-readable storage medium of claim 17, wherein the first operation data comprises:
a number of employees of the first client;
a location of the first client; and
products or services provided by the first client.

19. The non-transitory computer-readable storage medium of claim 15, wherein generating the first client profile further comprises:
extracting first features from the first operation data;
matching the first features to features associated with a plurality of classifications; and
classifying the first client into the first client classification using the first features, wherein the first client classification is one of the plurality of classifications.

20. The non-transitory computer-readable storage medium of claim 19, wherein matching the first client to the other ones of the plurality of clients further comprises:
determining that a second client comprises a second client classification identical to the first client classification, wherein the second client is one of the other ones of the plurality of clients.
